(19) United States
(12) Patent Application Publication
(10) Pub. No.: US 2008/0105769 A1
(43) Pub. Date: May 8, 2008

(54) COMPACT CHECK VALVE FOR SPRAY NOZZLE

(76) Inventor: Michael Ford Tschantz, Lexington, VA (US)

Correspondence Address: MEADWESTVACO CORPORATION, 1021 MAIN CAMPUS DRIVE, CENTENNIAL CAMPUS, RALEIGH, NC, 27606, US

(21) Appl. No.: 11/924,321

(22) Filed: Oct. 25, 2007

Related U.S. Application Data
(60) Provisional application No. 60/864,485, filed on Nov. 6, 2006.

(51) Int. Cl. B05B 1/00

(52) U.S. Cl. 239/569

(57) ABSTRACT

A compact check valve is described for use in a spray nozzle.

This non-provisional application relies on the filing date of provisional U.S. application Ser. No. 60/864,485 filed on Nov. 6, 2006, which is incorporated herein by reference, having been filed within twelve (12) months thereof, and priority thereto is claimed under 35 USC §1.19(e)

### BACKGROUND

Spray nozzles are used in many applications for providing a distributed pattern of a fluid material, usually a liquid, into a space or volume. For example in the process industries, spray nozzles may be used for humidifying, moistening, cleaning, scrubbing, stripping, coating, and other processes. The use of spray nozzles in a system to reduce hydrocarbon emissions is described in commonly owned provisional applications 60/744,543, 60/744,615, and 60/862,536 which were filed Apr. 10, Apr. 11, and Oct. 23, 2006, respectively.

In certain instances, it may be desired to provide a spray nozzle with a check valve in order to prevent back flow or reverse flow of fluid (liquid or air) through the nozzle.

### SUMMARY

This invention relates to a nozzle provided with a check valve. In one embodiment the combined nozzle and check valve have a low profile and may be used where space is limited.

### BRIEF DESCRIPTION OF THE DRAWINGS

FIG. 1 illustrates a pipe to which spray nozzles are attached, which passes through a small opening, and

FIG. 2 illustrates a cross section view of an assembled spray valve having a check valve.

### DETAILED DESCRIPTION

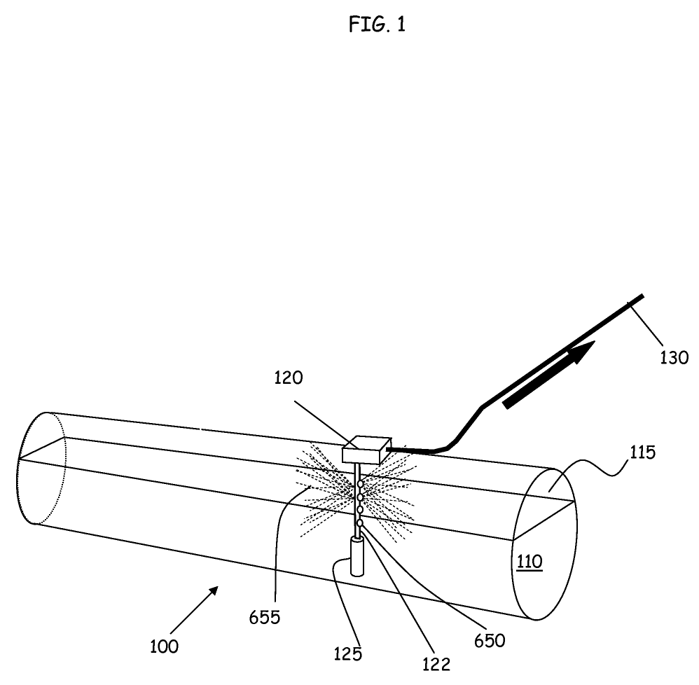

Most gasoline service stations in the United States use submersible turbine pumps (STP). FIG. 1 illustrates part of a gasoline delivery system where a tank 100 contains liquid gasoline 110 and an ullage 115 space that may contain air and gasoline vapors. A submersible pump may be used to pump gasoline from tank 100. Such a pump typically includes an upper part or head 120 that may be located out of the tank 100, for example in an access space or enclosure (not shown). The pump will also typically have submerged within the liquid phase 110 a sump portion 125 that may include a pickup, motor, and pump impeller such as a turbine. Between sump portion 125 and pump head 120 is a pipe 122 through which the pumped liquid may pass. This pipe 122 may have within it a conduit carrying electrical power to the motor. Liquid that is pumped from the sump portion 125 thus moves through pipe 122 to head 120, from whence it may be delivered to pump outlet line 130 to feed gas dispensers (commonly known as “gas pumps”) where customers may refuel their automobiles or other vehicles.

It has been described in the previously referenced applications how liquid fuel may be sprayed into the ullage space 115 from one or more spray devices 650 located in or on pipe 122. For example, these spray devices 650 may be nozzles in pipe 122 for allowing liquid (for example as spray 655) to pass from pipe 122 into the ullage space 115. The pump used may serve to supply the fuel dispensers through pump outlet line 130, or it may be provided as a separate pump.

A common submersible pump used at gasoline distribution facilities is manufactured by Red Jacket (a Veeder Root company). While the pump is in operation, the liquid may be at pressures between 10 psig and 70 psig. The pipe 122 may be tapped or converted such that sprayer nozzles may be fastened to the pipe. These nozzles may be of many varieties (including without limitation open cone, thin stream, fan spray, hydraulic atomizing, etc.) and any number of nozzles may be added, limited by the length and circumference of the pipe. An advantage of using the pipe between the sump and the head is that this part may be fairly accessible, for example for maintenance or replacement, and may thus lend itself to retrofitting with nozzles or other vaporizing devices.

When the pump is running, the pipe 122 becomes filled with liquid under pressure. If nozzles 650 are provided on pipe 122, they may provide a spray 655 as described previously. When the pump is not running, nozzles 650 may allow liquid to seep out of pipe 122, and air or vapor from the ullage space 115 may enter pipe 122. Having air or vapor within pipe 122 may be undesirable. In order to prevent incursion of air or vapor, a check valve may be incorporated into nozzle 650. In one embodiment a check valve may be provided that allows flow out through the nozzle when the pump is running, but then the check valve closes when the pump stops and the pressure within pipe 122 falls below a certain value.

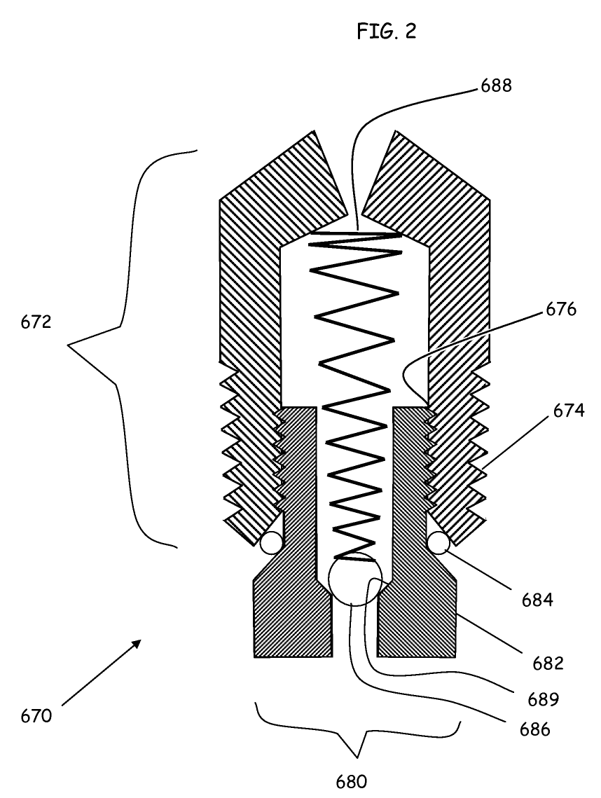

The pipe 122 that runs between the pump head 120 and the motor/turbine/pickup sump 125 is generally 1.5-2″ diameter. Such a pump may penetrate the tank through a four inch diameter female threaded bung (not shown). In order for the pump to fit through the bung, the nozzles 650 attached to pipe 122 preferably will be of a compact size. The addition of certain types or designs of check valve to the nozzle 650 may increase the nozzle size. It would be advantageous to have a compact design for a nozzle with a check valve. One such design is shown in FIG. 2.

FIG. 2 shows a cross section view of an assembly 670 including a spray nozzle and a check valve. Spray nozzle body 672 in this instance has external threads 674 so that it may be threaded into a source of fluid such as pipe 122. Check valve 680 is attached to the spray nozzle body 672, for example by threads 676 internal to the nozzle body 672 and external to the check valve body 682. A sealing member 684 such as an o-ring or gasket may be used to help seal the joint between nozzle body 672 and check valve body 682. Other sealing means may also be used, such as a sealant or pipe dope between threads 676. It should be understood that instead of threads 676, the nozzle body 672 and check valve body 682 may be held together by other means, for example by press fit, weld, and so on as would be evident to those skilled in the art. In FIG. 2, the check valve body 682 is shown protruding partly from the nozzle body 672, but it is possible that the design could be made to have the check valve body 682 flush with or within nozzle body 672.

Held between nozzle body 672 and check valve body 682 are a ball 686 and a spring 688. The spring 688 pushes ball 686 against a seat area, such as bevel 689. When the pump is running, fluid pressure pushes on the ball 686 and moves it away from bevel 689, allowing fluid to flow. When the pump is not running, or fluid pressure is not enough to counteract the force of spring 688, the ball will seat against bevel 689 and prevent flow.

Instead of ball 686, any other suitable shape may be used which is capable of forming a seal.

Methods of making and using the check valve in accordance with the invention should be readily apparent from the mere description of the structure and its varied appearances as provided herein. No further discussion or illustration of such methods, therefore, is deemed necessary.

While preferred embodiments of the invention have been described and illustrated, it should be apparent that many modifications to the embodiments and implementations of the invention can be made without departing from the spirit or scope of the invention. Although the example given here is for use of a spray nozzle in a particular gasoline service station system, the spray nozzle may be used elsewhere. It is understood therefore that the invention is not limited to the particular embodiments disclosed (or apparent from the disclosure) herein, but only limited by the claims appended hereto.

What is claimed as new and desired to be protected by Letters Patent of the United States is:

1. A spray nozzle, comprising:
an outer body part, and
an inner check valve.

2. The spray nozzle of claim 1, wherein said check valve comprises a sealing member for preventing back flow through said spray nozzle.

3. The spray nozzle of claim 2, wherein said sealing member is a ball.

4. The spray nozzle of claim 2, further comprising a spring element to bias said sealing member into a closed position.

5. The spray nozzle of claim 4, wherein said spring element is chosen to determine a set value of pressure at which said check valve changes from a closed to an open state.

6. The spray nozzle of claim 4, wherein said spring element comprises a helical or coil spring.

7. The spray nozzle of claim 5, wherein internal fluid pressure above said set value and in a forward flow direction opens said check valve and allows flow.

8. The spray nozzle of claim 5, wherein said check valve closes and prevents flow when internal fluid pressure is below said set value.

9. The spray nozzle of claim 1, wherein said check valve does not increase the outward extension of said spray nozzle.

10. The spray nozzle of claim 2, wherein said sealing member is contained in a cage part.

11. The spray nozzle of claim 10, wherein said cage part is held within said outer body part.

12. The spray nozzle of claim 10, wherein said cage part is threaded into said outer body part.

13. The spray nozzle of claim 10, further comprising a seal between said cage part and said outer body part.

14. The spray nozzle of claim 13, wherein said seal comprises an o-ring, gasket, or sealant material.
